(19) United States
(12) Patent Application Publication
(10) Pub. No.: US 2013/0236851 A1
(43) Pub. Date: Sep. 12, 2013

(54) ORAL CARE DEVICE

(71) Applicants: Justin E. McDonough, Flemington, NJ (US); Robert W. Fusi, II, Flemington, NJ (US); Richard J. Fougere, Washington Crossing, PA (US)

(72) Inventors: Justin E. McDonough, Flemington, NJ (US); Robert W. Fusi, II, Flemington, NJ (US); Richard J. Fougere, Washington Crossing, PA (US)

(21) Appl. No.: 13/413,760

(22) Filed: Mar. 7, 2012

(51) Int. Cl. A61C 17/02

(52) U.S. Cl. 433/89

(57) ABSTRACT

A device for directing a fluid onto a plurality of surfaces of the oral cavity, the device including a chamber for maintaining the fluid proximate the surfaces, where the chamber is defined by front, rear and base inner walls of the device and the front and rear inner walls each include a plurality of openings, the devices further including a first manifold a second manifold, a third manifold, and a fourth manifold, a first port, a second port, a third port, and a fourth port; and means for providing an effective seal of the device within the oral cavity.

### FIELD OF THE INVENTION

The present invention relates to oral care devices suitable for in-home use to provide a beneficial effect to the oral cavity of a mammal.

### BACKGROUND OF THE INVENTION

In addition to regular professional dental checkups, daily oral hygiene is generally recognized as an effective preventative measure against the onset, development, and/or exacerbation of periodontal disease, gingivitis and/or tooth decay. Unfortunately, however, even the most meticulous individuals dedicated to thorough brushing and flossing practices often fail to reach, loosen and remove deep-gum and/or deep inter-dental food particulate, plaque or biofilm. Most individuals have professional dental cleanings biannually to remove tarter deposits.

For many years products have been devised to facilitate the simple home cleaning of teeth, although as yet a single device which is simple to use and cleans all surfaces of a tooth and/or the gingival or sub-gingival areas simultaneously is not available. The conventional toothbrush is widely utilized, although it requires a significant input of energy to be effective and, furthermore, a conventional toothbrush cannot adequately clean the inter-proximal areas of the teeth. Cleaning of the areas between teeth currently requires the use of floss, pick, or some such other additional device apart from a toothbrush.

Electric toothbrushes have achieved significant popularity and, although these reduce the energy input required to utilize a toothbrush, they are still inadequate to ensure proper inter-proximal tooth cleaning. Oral irrigators are known to clean the inter-proximal area between teeth. However, such devices have a single jet which must be directed at the precise inter-proximal area involved in order to remove debris. These water pump type cleaners are therefore typically only of significant value in connection with teeth having braces thereupon which often trap large particles of food. It will be appreciated that if both debris and plaque are to be removed from teeth, at present a combination of a number of devices must be used, which is extremely time consuming and inconvenient.

In addition, in order for such practices and devices to be effective, a high level of consumer compliance with techniques and/or instructions is required. The user-to-user variation in time, cleaning/treating formula, technique, etc., will affect the cleaning of the teeth.

The present invention ameliorates one or more of the above mentioned disadvantages with existing oral hygiene apparatus and methods, or at least provides the market with an alternative technology that is advantageous over known technology, and also may be used to ameliorate a detrimental condition or to improve cosmetic appearance of the oral cavity.

### SUMMARY OF THE INVENTION

The invention is a device for directing a fluid onto a plurality of surfaces of the oral cavity of a mammal. The device includes a chamber for maintaining the fluid proximate the plurality of surfaces, where the internal space or volume of the chamber is defined and bounded by front and rear inner walls of the device and a base inner wall of the device, the base wall extending between the front and rear inner walls. The front and rear inner walls each include a plurality of openings, through which fluid is directed onto the surfaces of the oral cavity. The devices further includes a first manifold for containing a first portion of the fluid and providing the first portion to the chamber through first openings of said front inner wall, a second manifold for containing a second portion of the fluid and providing the first portion to the chamber through second openings of said front inner wall, a second third manifold for containing a second third portion of the fluid and providing the second third portion to the chamber through the third openings of the rear inner wall, and a fourth manifold for containing a fourth portion of the fluid and providing the fourth portion to the chamber through fourth openings of the rear inner wall. The device further includes a first port for conveying the first portion of fluid to and from the first manifold, a second port for conveying the second portion of fluid to and from the second manifold, a third port for conveying the third portion of fluid to and from the third manifold, a fourth port for conveying the fourth portion of fluid to and from the fourth manifold; and means for providing an effective seal of the device within said oral cavity.

### BRIEF DESCRIPTION OF THE DRAWINGS

FIG. 1 is a schematic drawing of one embodiment of a system using a device according to the present invention;

FIG. 2 is a schematic drawing of an alternative embodiment of a system using a device according to the present invention;

FIG. 3a is a perspective drawing of an embodiment of a reciprocating flow controller;

FIG. 3b is an exploded view of the reciprocating flow controller of FIG. 3a;

FIG. 3c is a top view of the reciprocating flow controller of FIG. 3a in its first position;

FIG. 3d is a top view of the reciprocating flow controller of FIG. 3a in its second position;

FIG. 4 is a top rear perspective view of an embodiment of a device according to the present invention;

FIG. 5 is a top front perspective view of the embodiment of the device of FIG. 4;

FIG. 6 is a top view of the device of FIG. 4;

FIG. 7 is a partial cross-sectional view of the device of FIG. 4;

FIG. 8 is a cross-sectional view of the device of FIG. 6 along the 8-8 plane;

FIG. 9a is a cut-away view of the device of FIG. 4 in a third operating mode;

FIG. 9b is a cut-away view of the device of FIG. 4 in a fourth operating mode;

FIG. 9c is cut-away view of the device of FIG. 4 in a fifth operating mode;

FIG. 10 is a cut-away view of a hand piece for use in the present invention;

FIG. 11a is a back, top perspective view of an embodiment of a system including the present invention;

FIG. 11b is a front, top perspective view of the system of FIG. 11a;

FIG. 11c is a back, top perspective view of the system of FIG. 11a, with the base station fluid reservoir attached to the base station; and

FIG. 11d is a front, top perspective view of the system of FIG. 11a, with the base station fluid reservoir attached to the base station.

### DETAILED DESCRIPTION OF THE INVENTION

The terms “reciprocating movement of fluid(s)” and “reciprocation of fluid(s)” are used interchangeably herein. As used herein, both terms mean alternating the direction of flow of the fluid(s) back and forth over surfaces of the oral cavity of a mammal from a first flow direction to a second flow direction that is opposite the first flow direction.

By “effective fit or seal”, it is meant that the level of sealing between the means for directing fluid onto and about the plurality of surfaces in the oral cavity which forms a part of the device according to the invention, e.g. an application tray or mouthpiece, is such that the amount of leakage of fluid from the device into the oral cavity during use is sufficiently low so as to reduce or minimize the amount of fluid used and to maintain comfort of the user, e.g. to avoid choking or gagging. Without intending to be limited, gagging is understood to be a reflex (i.e. not an intentional movement) muscular contraction of the back of the throat caused by stimulation of the back of the soft palate, the pharyngeal wall, the tonsillar area or base of tongue, meant to be a protective movement that prevents foreign objects from entering the pharynx and into the airway. There is variability in the gag reflex among individuals, e.g. what areas of the mouth stimulate it. In addition to the physical causes of gagging, there may be a psychological element to gagging, e.g. people who have a fear of choking may easily gag when something is placed in the mouth.

As used herein, “means for conveying fluid” includes structures through which fluid may travel or be transported throughout the systems and devices described herein and includes, without limitation passages, conduits, tubes, ports, portals, channels, lumens, pipes and manifolds. Such means for conveying fluids may be utilized in devices for providing reciprocation of fluids and means for directing fluids onto and about surfaces of the oral cavity. Such conveying means also provide fluid to the directing means and provides fluid to the reciprocation means from a reservoir for containing fluid, whether the reservoir is contained within a hand-held device containing the reciprocation means or a base unit. The conveying means also provides fluid from a base unit to a fluid reservoir contained within the hand-held device. Described herein are methods, devices and systems useful in providing a beneficial effect to an oral cavity of a mammal, e.g. a human.

Methods entail contacting a plurality of surfaces of the oral cavity with a fluid that is effective for providing the desired beneficial effect to the oral cavity. In such methods, reciprocation of the fluid(s) over the plurality of surfaces of the oral cavity may be provided under conditions effective to provide the desired beneficial effect to the oral cavity. Contact of the plurality of surfaces by the fluid may be conducted substantially simultaneous. By substantially simultaneous, it is meant that, while not all of the plurality of surfaces of the oral cavity are necessarily contacted by the fluid at the same time, the majority of the surfaces are contacted simultaneously, or within a short period of time to provide an overall effect similar to that as if all surfaces are contacted at the same time.

The conditions for providing the desired beneficial effect in the oral cavity may vary depending on the particular environment, circumstances and effect being sought. The different variables are interdependent in that they create a specific velocity of the fluid. The velocity requirement may be a function of the formulation in some embodiments. For example, with change in the viscosity, additives, e.g. abrasives, shear thinning agents, etc., and general flow properties of the formulation, velocity requirements of the jets may change to produce the same level of efficacy. Factors which may be considered in order to provide the appropriate conditions for achieving the particular beneficial effect sought include, without limitation, the velocity and/or flow rate and/or pressure of the fluid stream, pulsation of the fluid, the spray geometry or spray pattern of the fluid, the temperature of the fluid and the frequency of the reciprocating cycle of the fluid.

The fluid pressures, i.e. manifold pressure just prior to exit through the jets, may be from about 0.5 psi to about 30 psi, or from about 3 to about 15 psi, or about 5 psi. Flow rate of fluid may be from about 10 ml/s to about 60 ml/s, or about 20 ml/s to about 40 ml/s. It should be noted that the larger and higher quantity of the jets, the greater flow rate required at a given pressure/velocity. Pulse frequency (linked to pulse length and delivery (ml/pulse), may be from about 0.5 Hz to about 50 Hz, or from about 5 Hz to about 25 Hz. Delivery pulse duty cycle may be from about 10% to 100%, or from about 40% to about 60%. It is noted that at 100% there is no pulse, but instead a continuous flow of fluid. Delivery pulse volume (total volume through all jets/nozzles) may be from about 0.2 ml to about 120 ml, or from about 0.5 ml to about 15 ml. Velocity of jetted pulse may be from about 4 cm/s to about 400 cm/s, or from about 20 cm/s to about 160 in/s. Vacuum duty cycle may be from about 10% to 100%, or from about 50% to 100%. It is noted that vacuum is always on at 100%. Volumetric delivery to vacuum ratio may be from about 2:1 to about 1:20, or from about 1:1 to 1:10.

Once having the benefit of this disclosure, one skilled in the art will recognize that the various factors may be controlled and selected, depending on the particular circumstances and desired benefit sought.

The fluid(s) will include at least one ingredient, or agent, effective for providing the beneficial effect sought, in an amount effective to provide the beneficial effect when contacted with the surfaces of the oral cavity. For example, the fluid may include, without limitation, an ingredient selected from the group consisting of a cleaning agent, an antimicrobial agent, a mineralization agent, a desensitizing agent and a whitening agent. In certain embodiments, more than one fluid may be used in a single session. For example, a cleaning solution may be applied to the oral cavity, followed by a second solution containing, for example, a whitening agent or an antimicrobial agent. Solutions also may include a plurality of agents to accomplish more than one benefit with a single application. For example, the solution may include both a cleansing agent and an agent for ameliorating a detrimental condition, as further discussed below. In addition, a single solution may be effective to provide more than one beneficial effect to the oral cavity. For example, the solution may include a single agent that both cleans the oral cavity and acts as an antimicrobial, or that both cleans the oral cavity and whitens teeth.

Fluids useful for improving the cosmetic appearance of the oral cavity may include a whitening agent to whiten teeth in the cavity. Such whitening agents may include, without limitation, hydrogen peroxide and carbamide peroxide, or other agents capable of generating hydrogen peroxide when applied to the teeth. Such agents are well known within the art related to oral care whitening products such as rinses, toothpastes and whitening strips. Other whitening agents may include abrasives such as silica, sodium bicarbonate, alumina, apatites and bioglass.

It is noted that, while abrasives may serve to clean and/or whiten the teeth, certain of the abrasives also may serve to ameliorate hypersensitivity of the teeth caused by loss of enamel and exposure of the tubules in the teeth. For example, the particle size, e.g. diameter, of certain of the materials, e.g. bioglass, may be effective to block exposed tubules, thus reducing sensitivity of the teeth.

In some embodiments, the fluid may comprise an antimicrobial composition containing an alcohol having 3 to 6 carbon atoms. The fluid may be an antimicrobial mouthwash composition, particularly one having reduced ethanol content or being substantially free of ethanol, providing a high level of efficacy in the prevention of plaque, gum disease and bad breath. Noted alcohols having 3 to 6 carbon atoms are aliphatic alcohols. A particularly aliphatic alcohol having 3 carbons is 1-propanol.

In one embodiment the fluid may comprise an antimicrobial composition comprising (a) an antimicrobial effective amount of thymol and one or more other essential oils, (b) from about 0.01% to about 70.0% v/v, or about 0.1% to about 30% v/v, or about 0.1% to about 10% v/v, or about 0.2% to about 8% v/v, of an alcohol having 3 to 6 carbon atoms and (c) a vehicle. The alcohol may be 1-propanol. The fluid vehicle can be aqueous or non-aqueous, and may include thickening agents or gelling agents to provide the compositions with a particular consistency. Water and water/ethanol mixtures are the preferred vehicle.

Another embodiment of the fluid is an antimicrobial composition comprising (a) an antimicrobial effective amount of an antimicrobial agent, (b) from about 0.01% to about 70% v/v, or about 0.1% to about 30% v/v, or about 0.2% to about 8% v/v, of propanol and (c) a vehicle. The antimicrobial composition of this embodiment exhibits unexpectedly superior delivery system kinetics compared to prior art ethanolic systems. Exemplary antimicrobial agents which may be employed include, without limitation, essential oils, cetyl pyidium chloride (CPC), chlorhexidine, hexetidine, chitosan, triclosan, domiphen bromide, stannous fluoride, soluble pyrophosphates, metal oxides including but not limited to zinc oxide, peppermint oil, sage oil, sanguinaria, dicalcium dihydrate, aloe vera, polyols, protease, lipase, amylase, and metal salts including but not limited to zinc citrate, and the like. A particularly preferred aspect of this embodiment is directed to an antimicrobial oral composition, e.g. a mouthwash having about 30% v/v or less, or about 10% v/v or less, or about 3% v/v or less, of 1-propanol.

Yet another embodiment of the fluid is a reduced ethanol, antimicrobial mouthwash composition which comprises (a) an antimicrobial effective amount of thymol and one or more other essential oils; (b) from about 0.01 to about 30.0% v/v, or about 0.1% to about 10% v/v, or about 0.2% to about 8% v/v, of an alcohol having 3 to 6 carbon atoms; (c) ethanol in an amount of about 25% v/v or less; (d) at least one surfactant; and (e) water. Preferably the total concentration of ethanol and alcohol having 3 to 6 carbon atoms is no greater than 30% v/v, or no greater than 25% v/v, or no greater than 22% v/v.

In still another embodiment, the fluid is an ethanol-free antimicrobial mouthwash composition which comprises (a) an antimicrobial effective amount of thymol and one or more other essential oils; (b) from about 0.01% to about 30.0% v/v, or about 0.1% to about 10% v/v, or about 0.2% to about 8%, of an alcohol having 3 to 6 carbon atoms; (c) at least one surfactant; and (d) water.

The alcohol having 3 to 6 carbon atoms is preferably selected from the group consisting of 1-propanol, 2-propanol, 1-butanol, 2-butanol, tert-butanol and corresponding diols. 1-Propanol and 2-propanol are preferred, with 1-propanol being most preferred.

In addition to generally improving the oral hygiene of the oral cavity by cleaning, for example, removal or disruption of plaque build-up, food particles, biofilm, etc., the inventions are useful to ameliorate detrimental conditions within the oral cavity and to improve the cosmetic appearance of the oral cavity, for example whitening of the teeth. Detrimental conditions may include, without limitation, caries, gingivitis, inflammation, symptoms associated with periodontal disease, halitosis, sensitivity of the teeth and fungal infection. The fluids themselves may be in various forms, provided that they have the flow characteristics suitable for use in devices and methods of the present invention. For example, the fluids may be selected from the group consisting of solutions, emulsions and dispersions. In certain embodiments, the fluid may comprise a particulate, e.g. an abrasive, dispersed in a fluid phase, e.g. an aqueous phase. In such cases, the abrasive would be substantially homogeneously dispersed in the aqueous phase in order to be applied to the surfaces of the oral cavity. In other embodiments, an oil-in-water or water-in-oil emulsion may be used. In such cases, the fluid will comprise a discontinuous oil phase substantially homogeneously dispersed within a continuous aqueous phase, or a discontinuous aqueous phase substantially homogenously dispersed in a continuous oil phase, as the case may be. In still other embodiments, the fluid may be a solution whereby the agent is dissolved in a carrier, or where the carrier itself may be considered as the agent for providing the desired beneficial effect, e.g., an alcohol or alcohol/water mixture, usually having other agents dissolved therein.

Disclosed herein are devices, e.g. oral care devices, for example a dental cleaning apparatus, suitable for in-home use and adapted to direct fluid onto a plurality of surfaces of a tooth and/or the gingival area, as well as methods and systems utilizing such devices. In certain embodiments the surfaces of the oral cavity are contacted by the fluid substantially simultaneously. As used herein, reference to the gingival area includes, without limitation, reference to the sub-gingival pocket. The appropriate fluid may be directed onto a plurality of surfaces of teeth and/or gingival area substantially simultaneously in a reciprocating action under conditions effective to provide cleaning, and/or general improvement of the cosmetic appearance of the oral cavity and/or amelioration of a detrimental condition of the teeth and/or gingival area, thereby providing generally improved oral hygiene of teeth and/or gingival area. For example, one such device cleans teeth and/or the gingival area and removes plaque using an appropriate cleaning fluid by reciprocating the fluid back and forth over the front and back surfaces and inter-proximal areas of the teeth, thereby creating a cleaning cycle while minimizing the amount of cleaning fluid used.

Devices that provide reciprocation of the fluid comprise a means for controlling reciprocation of the fluid. The controlling means include means for conveying the fluid to and from a means for directing the fluid onto the plurality of surfaces of the oral cavity. In certain embodiments, the means for providing reciprocation of the fluid comprises a plurality of portals for receiving and discharging the fluid, a plurality of passages, or conduits, through which the fluid is conveyed, and means for changing the direction of flow of the fluid to provide reciprocation of the fluid, as described in more detail herein below. The controlling means may be controlled by a logic circuit and/or a mechanically controlled circuit.

In certain embodiments, devices for providing reciprocation may include a means for attaching or connecting the device to a reservoir for containing the fluid. The reservoir may be removably attached to the device. In this case, the reservoir and the device may comprise means for attaching one to the other. After completion of the process, the reservoir may be discarded and replaced with a different reservoir, or may be refilled and used again. In other embodiments, the reciprocating device will include a reservoir integral with the device. In embodiments where the device may be attached to a base unit, as described herein, the reservoir, whether integral with the device or removably attached to the device, may be refilled from a supply reservoir which forms a part of the base unit. Where a base unit is utilized, the device and the base unit will comprise means for attaching one to the other.

The device will comprise a power source for driving the means for reciprocating fluids. The power source may be contained within the device, e.g. in the handle of the device, for example, batteries, whether rechargeable or disposable. Where a base unit is employed, the base may include means for providing power to the device. In other embodiments, the base unit may include means for recharging the rechargeable batteries contained within the device.

Devices for providing reciprocation of fluids will include means for attaching the device to means for directing the fluid onto the plurality of surfaces of the oral cavity, e.g. application tray or mouthpiece according to the invention. In certain embodiments, the directing means provides substantially simultaneous contact of the plurality of surfaces of the oral cavity by the fluid. The attachment means may provide removable attachment of the tray or mouthpiece to the device. In such embodiments, multiple users may use their own mouthpiece with the single device comprising the reciprocating means. In other embodiments, the attachment means may provide a non-removable attachment to the mouthpiece, whereby the mouthpiece is an integral part of the device. Devices for providing reciprocation as described above may be contained within a housing also containing other device components so as to provide a hand-held device suitable for providing fluid to the directing means, as described herein below.

Devices of the present invention comprise a chamber for maintaining the fluid proximate the plurality of surfaces, i.e. liquid-contacting-chamber (LCC). By “proximate”, it is meant that the fluid is maintained in contact with the surfaces. The LCC is defined by the space bounded by the front inner wall and rear inner wall of the mouthpiece, and a wall, or membrane, extending between and integral with the front and rear inner walls of the mouthpiece, and in certain embodiments, a rear gum-sealing membrane. Together, the front and rear inner walls, the wall extending there between and rear gum-sealing membrane form the LCC membrane (JCCM). The general shape of the LCCM is that of a “U” or an “n”, depending on the orientation of the mouthpiece, which follows the teeth to provide uniform and optimized contact by the fluid. The LCCM may be flexible or rigid depending on the particular directing means. The membrane may be located as a base membrane of the LCCM. The front and rear inner walls of the LCCM each include a plurality of openings, or slots, through which the fluid is directed to contact the plurality of surfaces of the oral cavity.

The LCCM design may be optimized for maximum effectiveness as it relates to the size, shape, thickness, materials, volume created around the teeth/gingiva, nozzle design and placement as it relates to the oral cavity and the teeth in conjunction with the manifold and gingival margin seal to provide comfort and minimize the gagging reflex of the user. The combination of the above provides effective contact of the teeth and gingival area by the fluid.

The LCCM provides a controlled and isolated environment with known volume, i.e. the LCC, to contact teeth and/or gingival area with fluids, and then to remove spent fluids, as well as debris, plaque, etc., from the LCC without exposing the whole oral cavity to fluid, debris, etc. This decreases the potential for ingestion of the fluids. The LCCM also allows increased flow rates and pressure of fluids without drowning the individual when significant flow rates are required to provide adequate cleaning, for example. The LCCM also allows reduced fluid quantities and flow rates when required, as only the area within the LCC is being contacted with fluid, not the entire oral cavity. The LCCM also allows controlled delivery and duration of contact of fluid on, through and around teeth and the gingival area, allowing increased concentrations of fluids on the area being contacted by the fluid, thereby providing more effective control and delivery of fluid.

The thickness of the walls of the LCCM may be within a range of 0.2 mm to 1.5 mm, to provide necessary physical performance properties, while minimizing material content, and optimizing performance. The distance between the inner walls of the LCCM to the teeth may be from about 0.1 mm to about 5 mm, and more typically an average distance of about 2.5 mm to provide maximum comfort, while minimizing customization and LCC volume requirements.

The size and shape of the mouthpiece preferably utilizes three basic universal sizes (small, medium and large) for both the top and bottom teeth, but the design provides mechanisms to allow different levels of customization as required to ensure comfort and functionality to the individual user. The device may incorporate a switching mechanism, which would allow it to be operable only when in the correct position in the mouth. The mouthpiece may include both upper and lower sections to provide substantially simultaneous contact of the plurality of surfaces of the oral cavity by fluid. In an alternate embodiment the upper and lower sections may be cleaned utilizing a single bridge that could be used on the upper or lower teeth and gums of the user (first placed one portion for cleaning, then subsequently placed over the other portion for cleaning).

The number and location of openings, also referred to herein as slots, jets or nozzles, contained within the inner walls of the mouthpiece through which the fluid is directed will vary and be determined based upon the circumstances and environment of use, the particular user and the beneficial effect being sought. The cross-sectional geometry of the openings may be circular, elliptical, trapezoidal, or any other geometry that provides effective contact of the surfaces of the oral cavity by the fluid. The location and number of openings may be designed to direct jets of fluid in a variety of spray patterns effective for providing the desired beneficial effect. Opening diameters may be from about 0.1 to about 3 mm, or from about 0.2 mm to about 0.8 mm, or about 0.5 mm, to provide effective cleaning and average jet velocities and coverage.

Optimal opening placement and direction/angles allows coverage of substantially all teeth surfaces in the area if the oral cavity to be contacted by fluid, including but not limited to interdental, top, side, back, and gingival pocket surfaces. In alternate embodiments, the openings could be of different sizes and different shapes to provide different cleaning, coverage and spray patterns, to adjust velocities, density and fan patterns (full cone, fan, partial, cone, jet), or due to formulation consideration. Nozzles could also be designed to be tubular and or extend from the LCC membrane to provide directed spray, or act as sprinkler like mechanism to provide extended coverage across the teeth, similar to a hose sprinkler system. The nozzles are preferably integral to the inner walls of the LCC membrane and can be incorporated into the inner walls through any number of assembly or forming techniques known in the art (insert molded, formed in membrane through machining, injection molding, etc.).

The LCCM may be an elastomeric material such as ethylene vinyl acetate (EVA), thermoplastic elastomer (TPE), or silicone, to allow motion of the inner walls and provide a greater jet coverage area with minimal mechanics, reducing the volumetric flow requirements to achieve optimized performance, while providing a softer and more flexible material to protect the teeth if direct contact with the teeth is made. A flexible membrane may also provide acceptable fitment over a large range of users, due to its ability to conform to the teeth. Alternatively, the LCCM could be made of a rigid or semi-rigid material, such as but not limited to a thermoplastic.

In an alternate embodiment, the LCCM could also include abrasive elements such as filaments, textures, polishing elements, additives (silica, etc.), and other geometric elements that could be used for other cleaning and/or treatment requirements as well as ensuring minimal distance between the teeth and LCCM for, but not limited to, treatment, cleaning, and positioning.

The LCCM could be created via a variety of methods such as, but not limited to, machining, injection molding, blow molding, extrusion, compression molding, and/or vacuum forming. It can also be created in conjunction with the manifold, but incorporating the manifold circuitry within the LCC, and/or over-molded onto the manifold to provide a unitary construction with minimal assembly.

In one embodiment, the LCCM may be fabricated separately and then assembled to the manifolds, utilizing any number of assembling and sealing techniques, including adhesives, epoxies, silicones, heat sealing, ultrasonic welding, and hot glue. The LCCM is designed in a way that, when assembled with the manifold, it effectively and efficiently creates the preferred multi-manifold design without any additional components.

In certain embodiments, the LCCM can also be designed or used to create the gingival sealing area. In certain embodiments, a vacuum is applied within the LCC, which improves the engagement of the mouthpiece to form a positive seal with the gingival in the oral cavity. In other embodiments, a pressure is applied outside the LCCM, within the oral cavity, which improves the engagement of the mouthpiece to form a positive seal with the gingival in the oral cavity. In yet other embodiments, a denture-like adhesive may be applied around the mouthpiece during the initial use to provide a custom reusable resilient seal when inserted into the oral cavity for a particular user. It would then become resiliently rigid to both conform and provide a positive seal with the guns and on subsequent applications. In another embodiment, the seal could be applied and/or replaced or disposed of after each use.

Devices of the invention also comprises a first manifold for containing the fluid and for providing the fluid to the LCC through the openings of the front inner wall, and a second manifold for containing the fluid and for providing the fluid to the chamber through the openings of the rear inner wall. This design provides a number of different options, depending on what operation is being conducted. For instance, in a cleaning operation, it may be preferable to deliver jets of fluid into the LCC directly onto the teeth from one side of the LCC from the first manifold and then evacuate/pull the fluid around the teeth from the other side of the LCC into the second manifold to provide controlled interdental, gumline and surface cleaning. This flow from the one side of the LCC could be repeated a number of times in a pulsing action before reversing the flow to deliver jets of fluid from the second manifold and evacuating/pulling the fluid through the back side of the teeth into the first manifold for a period of time and/or number of cycles. Such fluid action creates a turbulent, repeatable and reversible flow, thus providing reciprocation of the fluid about the surfaces of the oral cavity.

In alternate embodiments, the manifold can be of single manifold design providing pushing and pulling of the fluid through the same sets of jets simultaneously, or can be any number of manifold divisions to provide even greater control of the fluid delivery and removal of the cleaning and fluid treatment. In the multi-manifold also can be designed to have dedicated delivery and removal manifolds. The manifolds can also be designed to be integral to and/or within the LCCM.

The material for the manifold would be a semi-rigid thermoplastic, which would provide the rigidity necessary not to collapse or burst during the controlled flow of the fluids, but to provide some flexibility when fitting within the user's mouth for mouthpiece insertion, sealing/position and removal. To minimize fabrication complexity, number of components and tooling cost, the dual manifold is created when assembled with the LCCM. The manifold could also be multi-component to provide a softer external “feel” to the teeth/gums utilizing a lower durometer elastomeric material, such as, but not limited to, a compatible thermoplastic elastomer (TPE). The manifold could be created via a variety of methods such as, but not limited to machining, injection molding, blow molding, compression molding, or vacuum forming.

Devices of the invention also comprise a first port for conveying the fluid to and from the first manifold and a second port for conveying the fluid to and from the second manifold, and means for providing an effective seal of the directing means within the oral cavity, i.e. a gingival seal. In certain embodiments, the first and second ports may serve both to convey fluid to and from the first and second manifolds and to attach the mouthpiece to the means for providing fluid to the mouthpiece. In other embodiments, the directing means may further include means for attaching the directing means to means for providing fluid to the directing means.

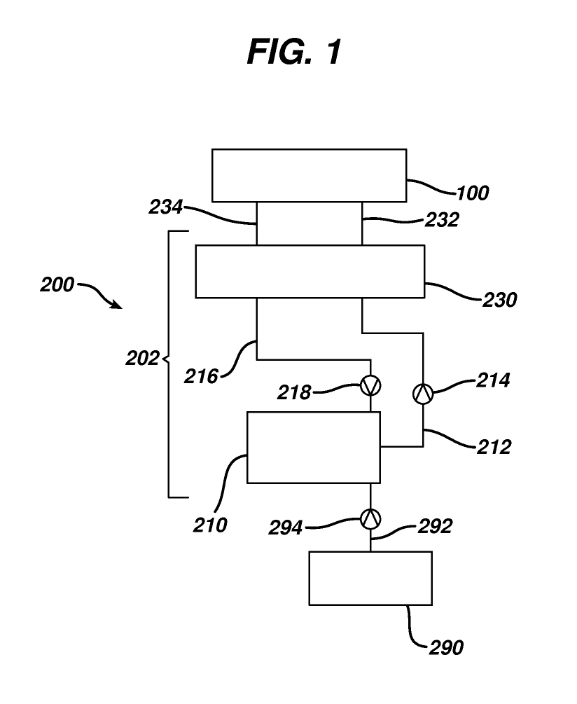

FIG. 1 is a schematic drawing of an embodiment of a system utilizing devices according to the present invention. The figure shows system 200, with components including: means for providing reciprocation of fluid in the oral cavity 202, means for directing the fluid onto the plurality of surfaces of the oral cavity, in this instance shown as application tray 100, and fluid supply reservoir 290. Means for providing reciprocation of fluids may include, in this embodiment, delivery/collection device 210, reciprocating flow controller 230, tubes 212, 216, and 292 for conveying the fluid throughout the system, and fluid one-way flow valves 214, 218 and 294. Tubes 232 and 234 provide for conveyance of the fluid from reciprocating flow controller 230 to application tray 100.

In some embodiments, delivery/collection device 210 may be a piston pump. Fluid supply reservoir 290 may be made of glass, plastic or metal. Fluid supply reservoir 290 may be integral to system 200 and refillable. In some embodiments, fluid supply reservoir 290 may be a replaceable fluid supply, such as a single or multi-use cartridge, detachably connected to system 200.

In some embodiments, fluid supply reservoir 290 and/or tubes 212, 292, may include a heat source to pre-warm the fluid prior to direction into application tray 100 for application to the surfaces of the oral cavity. The temperature should be maintained within a range effective to provide efficacy and comfort to the user during use.

Application tray 100, discussed in detail herein below, could be integral with, or detachably connected to reciprocating means 202 by way of tubes 232, 234 and further attachment means (not shown). It could be one or two sided with internally, easily cleanable filters for trapping food particles. When positioned within the oral cavity, e.g. about the teeth and gums, tray 100 forms an effective fit or seal against the gums, and includes means to direct fluid against surfaces of the oral cavity, e.g. surfaces of the teeth.

Fluid in fluid supply reservoir 290 flows through tube 292 to delivery/collection device 210. Fluid flow through tube 292 is controlled by one-way flow valve 294. From delivery/collection device 210, fluid flows through tube 212 to reciprocating flow controller 230. One-way flow valve 214 controls the fluid flow through tube 212. Fluid flows from reciprocating flow controller 230 to application tray 100 either through tube 232 or 234, depending on the flow direction setting of reciprocating flow controller 230. Fluid flows from application tray 100, through either tube 234 or 232 back to reciprocating flow controller 230, and from reciprocating flow controller 230 to delivery/collection device 210, through tube 216. One-way flow valve 218 controls the fluid flow through tube 216.

The actions of delivery/collection device 210 may be controlled by a logic circuit, which may include a program to start the reciprocation cycle, a program to execute the reciprocation cycle, i.e. to cause fluid to be reciprocated about the teeth, thereby providing the beneficial effect to the oral cavity, e.g. cleaning the teeth, a program to empty application tray 100 at the end of the reciprocation cycle, and a self-cleaning cycle to clean the system between uses, or at pre-set or automatic cleaning times.

Though not shown, a face panel with a series of switches and indicator lights may also be incorporated into system 200. Switches may include, but are not limited to, on/off, fill application tray 100, run the reciprocation program, empty system 200, and clean system 200. Indicator, or display, lights include, but are not limited to, power on, charging, reciprocation program running, system emptying, cleaning results or feedback, and self-cleaning cycle in operation. In embodiments where fluid is pre-warmed prior to direction into application tray 100, a display light could be used to indicate that the fluid is at the proper temperature for use.

One method of using system 200 to clean teeth is as follows. In the first step, the user positions application tray 100 in the oral cavity about the teeth and gingival area. The user closes down on tray 100, thereby achieving an effective fit or seal between gums, teeth and tray 100. In use of the system according to the invention, the user pushes a start button initiating the cleaning process. The cleaning process is as follows:
1. Delivery/collection device 210 is activated to begin drawing cleaning fluid from fluid supply reservoir 290 through tube 292 and one-way flow valve 294.
2. Once delivery/collection device 210 is sufficiently filled, delivery/collection device 210 is activated to begin dispensing cleaning fluid to application tray 100 via tube 212, one-way valve 214, reciprocating flow controller 230, and tube 232. Cleaning fluid will be prevented from flowing through tubes 216 and 292 by one-way flow valves 218 and 294, respectively.
3. Delivery/collection device 210 is activated to begin drawing cleaning fluid from application tray 100 through tube 234, then through reciprocation flow controller 230, then through tube 216 and one-way flow valve 218. Cleaning fluid will be prevented from flowing through tube 212 by one-way flow valve 214. If there is insufficient cleaning fluid to adequately fill delivery/collection device 210, additional cleaning fluid may be drawn from fluid supply reservoir 290 through tube 292 and one-way flow valve 294.
4. The direction of the fluid flow is then reversed.
5. To reciprocate the cleaning fluid, steps 2 and 3 are repeated after the flow direction is reversed, cycling cleaning fluid between delivery/collection device 210 and application tray 100, using tubes 234 and 232, respectively.
6. The reciprocation cycle described continues until the time required for cleaning has expired, or the desired numbers of cycles are complete.

It is noted that there may be a delay between steps 2 and 3 (in either or both, directions), allowing a dwell time where the fluid is allowed to contact the teeth without flow.

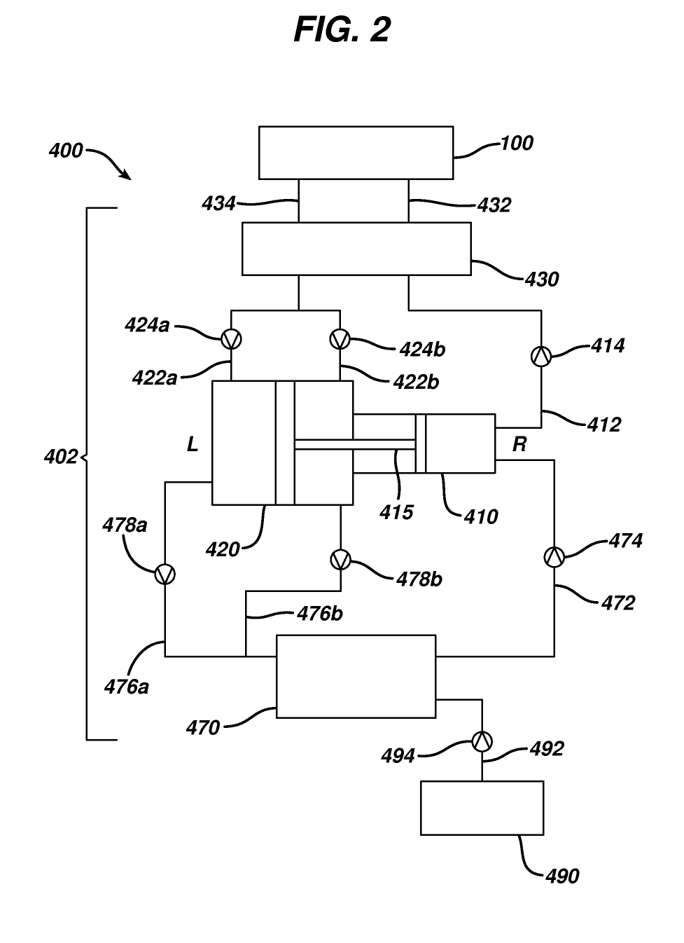

FIG. 2 is a schematic drawing of a first alternative embodiment of a system utilizing devices according to the present invention. The figure shows system 400, with components including: means for providing reciprocation of fluids in the oral cavity 402, fluid reservoir 470, fluid supply reservoir 490, and means for directing the fluid onto the plurality of surfaces of the oral cavity, in this instance shown as application tray 100. Means for providing reciprocation 402 may include delivery device 410, collection device 420, reciprocating flow controller 430, tubes 412, 422a, 422b, 472, 476, and 492, and solution one-way flow valves 414, 424a, 424b, 474, 478, and 494. Tubes 432 and 434 provide for conveyance of the fluid from reciprocating flow controller 430 to application tray 100.

In the present embodiment, delivery device 410 and collection device 420 are housed together as a duel action piston pump, with common piston 415. Fluid supply reservoir 490 and fluid reservoir 470 may be made of glass, plastic, or metal. Fluid supply reservoir 490 may be integral to system 400 and refillable. In some embodiments, fluid supply reservoir 490 may be a replaceable fluid supply, detachably connected to system 400.

In some embodiments, any of fluid supply reservoir 490, fluid reservoir 470, or tubes 412, 472, 492, may include a heat source to pre-warm cleaning solution prior to direction into application tray 100 for application to the teeth. The temperature should be maintained within a range effective to provide comfort to the user during use.

Application tray 100 could be integral with, or detachably connected to reciprocating means 402 by way of tubes 432, 434 and other attachment means (not shown).

Fluid in fluid supply reservoir 490 flows through tube 492 to fluid reservoir 470. Fluid in fluid reservoir 470 flows through tube 472 to delivery device 410. Fluid flow through tube 472 is controlled by one-way flow valve 474. From delivery device 410, fluid flows through tube 412 to reciprocating flow controller 430. One-way flow valve 414 controls the fluid flow through tube 412. Fluid flows from reciprocating flow controller 430 to application tray 100 through tube 432 or tube 434, depending on the flow direction. Fluid flows from application tray 100, through tube 434 or tube 432, again depending on the flow direction, back to reciprocating flow controller 430, and from reciprocating flow controller 430 to collection device 420, through tubes 422a and 422b. One-way flow valves 424a and 424b control the fluid flow through the tubes. Finally, fluid flows from collection device 420 to fluid reservoir 470 through tubes 476a and 476b. One-way flow valves 478a and 478b control the fluid flow through the tubes.

The actions of delivery device 410 and collection device 420 may be controlled by a logic circuit, which may include a program to the start reciprocation cycle, a program to execute the reciprocation cycle, i.e. to cause solution to be reciprocated about the plurality of the surfaces of the oral cavity, thereby providing the beneficial effect, a program to empty application tray 100 at the end of the cycle, and a self-cleaning cycle to clean the system between uses, or at pre-set or automatic cleaning times.

System 400 may also include switches such as on/off, fill application tray 100, execute cleaning process, empty system 400, and clean system 400, and indicator, or display, lights including, but are not limited to, power on, charging, reciprocation program running, device emptying, and self-cleaning cycle in operation. In embodiments where fluid is pre-warmed prior to direction into application tray 100, a display light could be used to indicate that the fluid is at the proper temperature for use.

One method of using system 400 to clean teeth is as follows. Prior to use, cleaning fluid in fluid supply reservoir 490 flows through tube 492 and one-way valve 494 to cleaning fluid reservoir 470. In some embodiments, fluid supply reservoir 490 is now disconnected from system 400.

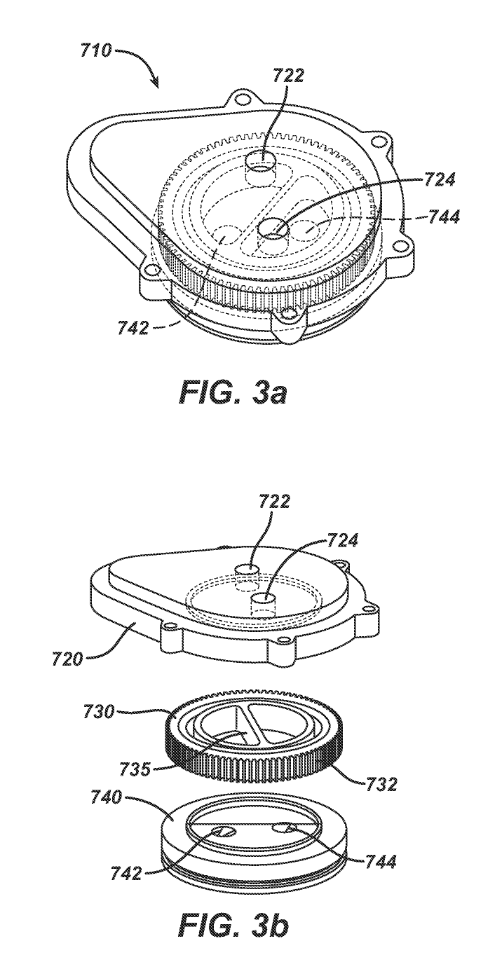

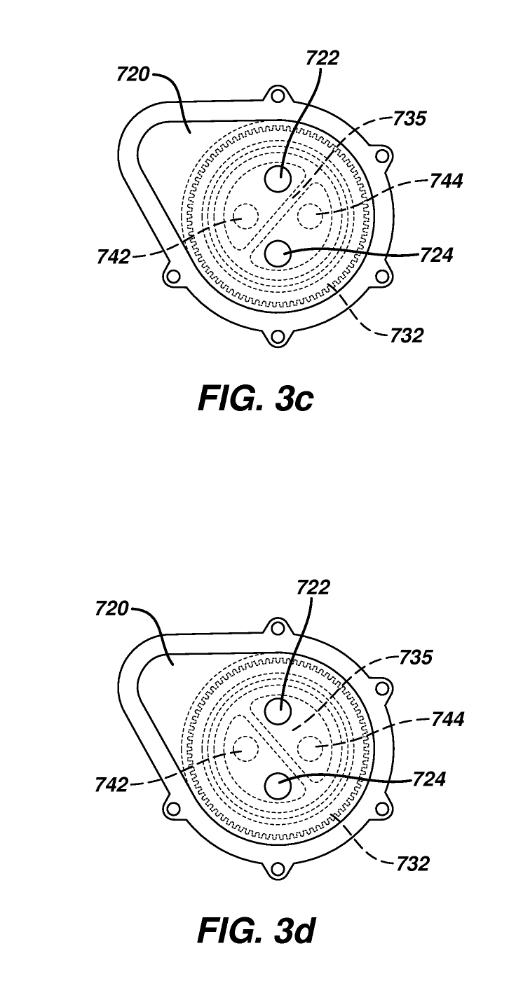

In the first step, the user positions application tray 100 in the oral cavity about the teeth and gingival area. The user closes down on tray 100, thereby achieving an effective fit or seal between gums, teeth and tray 100. The user pushes a start button initiating the cleaning process. The cleaning process is as follows:
1. Piston 415 is activated to begin drawing cleaning fluid to delivery device 410 from cleaning fluid reservoir 470 through tube 472 and one-way flow valve 474. To accomplish this, piston 415 translates from right to left (“R” to “L” on FIG. 3).
2. Once delivery device 410 is sufficiently filled, delivery device 410 is activated to begin dispensing cleaning fluid to application tray 100 via tube 412, one-way flow valve 414, reciprocating flow controller 430, and tube 432. To accomplish this, piston 415 translates from left to right (“L” to “R” on FIG. 3). The “L” to “R” motion of piston 415 causes collection device 420 to begin drawing cleaning fluid from application tray 100 via tube 434, reciprocating flow controller 430, tube 422a, and one-way flow valve 424a. Cleaning fluid will be prevented from flowing through tubes 472 and 422a, by one-way flow valves 474 and 424b. Any excess cleaning fluid in collection device 420 will begin dispensing to cleaning fluid reservoir 470 via tube 476b and one-way valve 478b. Cleaning fluid will be prevented from flowing through tube 422b by one-way flow valve 424b.
3. To cycle cleaning solution, steps 1 and 2 are repeated, cycling cleaning fluid between cleaning fluid reservoir 470 and application tray 100
4. The process continues to run until the time required for cleaning has expired, or the desired numbers of cycles are complete.

Each embodiment described in FIG. 1 and FIG. 2 includes reciprocating flow controller (230, 430 in FIG. 1, FIG. 2, respectively). A perspective drawing and an exploded view of an embodiment of a reciprocating flow controller according to the present invention is shown in FIG. 3a and FIG. 3b, respectively. The figures show reciprocating flow controller 710 with cap 720, flow diverter disk 730, and base 740. Cap 720 has cap ports 722 and 724. Base 740 has base ports 742 and 744. Flow diverter disk 730 is disposed between cap 720 and base 740, and has panel 735 for diverting fluid flow, and position adjuster 732 in the form of a gear.

FIG. 3c is a top view of reciprocating flow controller 710 in its first position. In this position, incoming fluid, such as fluid in tube 212 of FIG. 1, enters reciprocating flow controller 710 through base port 742. The fluid exits reciprocating flow controller 710 through cap port 722, such as fluid in tube 232 of FIG. 1. Returning fluid, such as fluid in tube 234 of FIG. 1, reenters reciprocating flow controller 710 through cap port 724. The fluid re-exits reciprocating flow controller 710 through base port 744, such as fluid in tube 216 of FIG. 1.

FIG. 3d is a top view of the reciprocating flow controller 710 in its second position. In this position, incoming fluid, such as fluid in tube 212 of FIG. 1, enters reciprocating flow controller 710 through base port 742. The fluid exits reciprocating flow controller 710 through cap port 724 such as fluid in tube 234 of FIG. 1. Returning fluid, such as fluid in tube 232 of FIG. 1, reenters reciprocating flow controller 710 through cap port 722. The fluid exits reciprocating flow controller 710 through base port 744, such as fluid in tube 216 of FIG. 1.

Reciprocation of fluid in application tray 100 of FIG. 1 is achieved by switching reciprocating flow controller 710 between its first and second positions. It has been found that the width of panel 735 relative to the diameters of cap ports 722 and 724 and base ports 742 and 744 is critical to the performance of reciprocating flow controller 710. If the width of panel 735 is equal to or greater than any of the diameters, then one or more of cap ports 722 and 724 or base ports 742 and 744 may be blocked, or isolated, during part of the reciprocation, resulting in suboptimal performance or device failure. A channel may be located in panel 735 to avoid this condition.

The oral hygiene system may be comprised of several major components including, but not limited to, a base station, a hand piece for containing means for providing reciprocation of fluid about the plurality of surfaces within the oral cavity, and the application tray, or mouthpiece. The system is suitable for in-home use and adapted to direct fluid onto a plurality of surfaces of a tooth simultaneously. The device cleans teeth and removes plaque using cleaning solution that is reciprocated back and forth creating a cleaning cycle and minimizing cleaning solution used. The device could be hand held, or may be in the form of a table or counter-top device.

The base station will charge a rechargeable battery in the hand piece, hold fluid reservoirs, house diagnostic components, provide feedback to the user, and potentially clean the mouthpiece.

The hand piece will have a powered pump that will deliver fluid from the reservoir to the mouthpiece. The direction of flow may be reciprocated with fluid control valving, by a specialized pump (reversing its direction, etc), reversible check valves, or other similar means. The cycle time and flow velocity for each stage of the cycle will be variable and in some embodiments, be customized to each individual user. The hand piece will perform a filling process, and a cleaning and/or purging process. The hand piece and/or base station may provide feedback to the user for each stage of the process and potentially report diagnostic information.

The hand piece will be aesthetically pleasing and have a grip/feel comfortable for the user's hand. The weight and balance will be well suited to comfortable and efficient use while giving a high quality feel. Finger grips and/or touch points will be appropriately located for comfort, grip, feel, and assistance in proper orientation and grip location of the hand piece. The base station will also be aesthetically pleasing and allow the hand piece to easily and securely dock into position. The base station may or may not lock the hand piece into position once it's docked.

The third major component of the apparatus is the application tray, or mouthpiece.

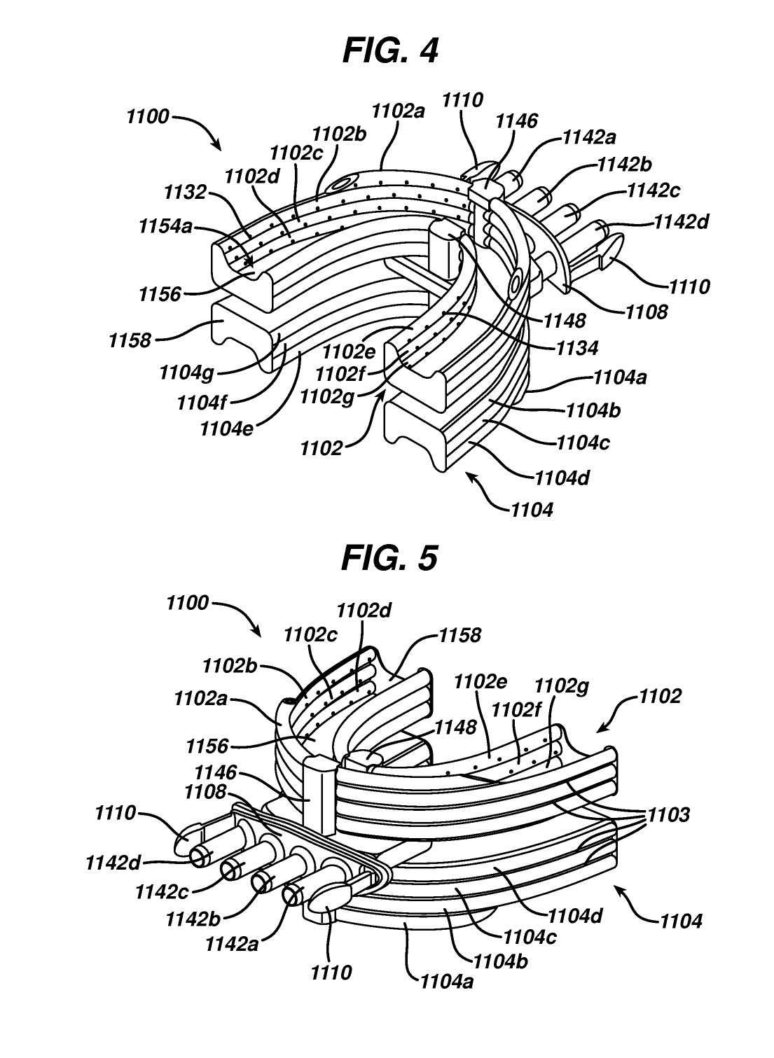

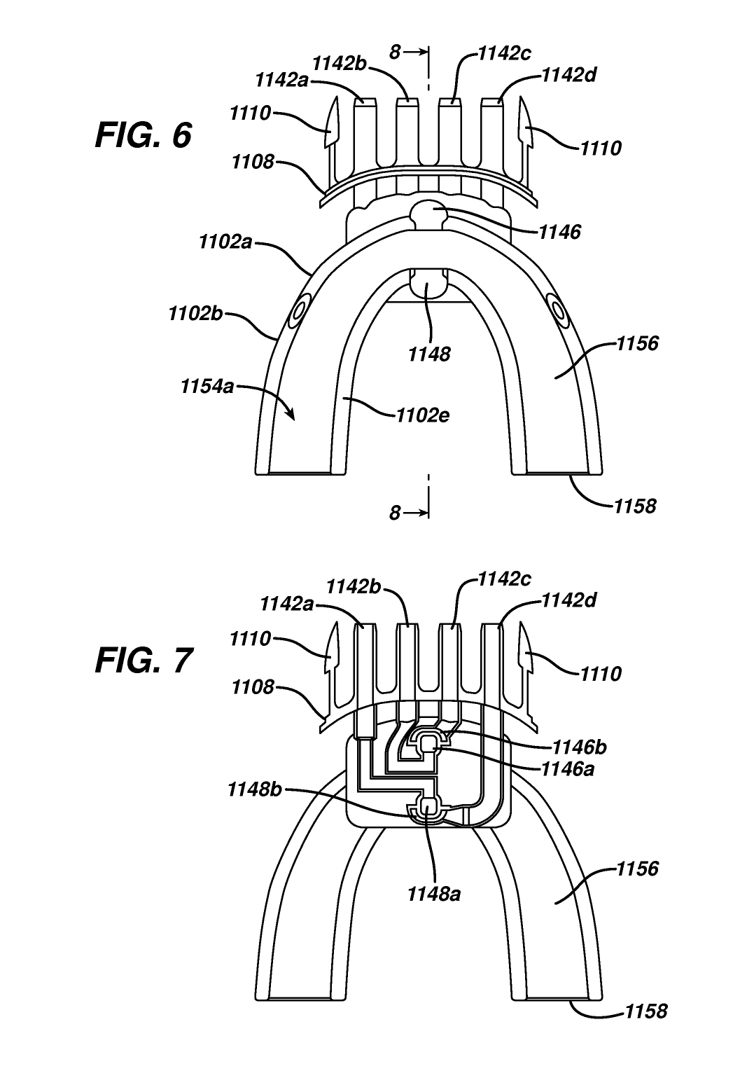

FIG. 4 is a top, rear perspective view of an embodiment of an application tray 1100 according to the present invention. FIG. 5 is a top, front perspective view of the application tray 1100 of FIG. 4, while FIG. 6 is a top view of the application tray of FIG. 4. The figures show application tray 1100 with top piece 1102, bottom piece 1104, first port 1142a, second port 1142b, third port 1142c, forth port 1142d, and support plate 1108 fixedly attached to the front of said application tray. First port 1142a, second port 1142b, third port 1142c, and forth port 1142d, enter application tray 1100 and extend through support plate 1108.

Optional quick disconnect structures, e.g. barbs, 1110 are attached to support plate 1108, allowing application tray 1100 to be quickly and easily attached to and then disconnected from means for providing fluid to the application tray, such as may be contained in the housing of a cleaning system. The housing would include structure effective to receive such quick disconnect barbs, or similar quick disconnect structure, in attachable engagement, to detachably connect the application tray to the housing. The quick disconnect option could be used to replace used or worn application trays, or to change application trays for different users. In some embodiments, a single user may change application trays to change the flow characteristics for different options, such as number of cleaning nozzles, nozzle velocity, spray pattern, and locations, coverage area, etc.

FIGS. 4 to 8 depict an embodiment of an application tray 1100 in which the user's top and bottom teeth and/or gingival area are substantially simultaneously contacted with fluid. It should be understood that in other embodiments, application tray 1100 may be designed to contact only the top or bottom teeth or gingival area of the user with fluid.

Top piece 1102 has front fluid lumens 1102a, 1102b, 1102c, and 1102d, back fluid lumens 1102e, 1102f, and 1102g, first manifold 1146, second manifold 1148, base membrane 1156, and back gum-sealing membrane 1158. Front fluid lumens 1102a, 1102b, 1102c, and 1102d are all connected by first manifold 1146. Likewise, back fluid lumens 1102e, 1102f, and 1102g, are all connected by second manifold 1148.

Bottom piece 1104, may be a mirror image of top piece 1102, and has front fluid lumens 1104a, 1104b, 1104c, and 1104d, back fluid lumens 1104e, 1104f, and 1104g, first manifold 1146, second manifold 1148, base membrane 1156, and back gum-sealing membrane 1158. Front fluid lumens 1104a, 1104b, 1104c, and 1104d are all connected by first manifold 1146. Likewise, back fluid lumens 1104e, 1104f, and 1104g, are all connected by second manifold 1148.

Though FIGS. 4 and 5 show top piece 1102 with four front fluid lumens (1102a, 1102b, 1102c, and 1102d) and three back fluid lumens (1102e, 1102f, and 1102g), top piece 1102 may also be formed with two, three, five, six, or even seven front or back fluid lumens. Likewise, bottom piece 1104 is shown with four front fluid lumens (1104a, 1104b, 1104c, and 1104d) and three back fluid lumens (1104e, 1104f, and 1104g), bottom piece 1104 may also be formed with two, three, five, six, or even seven front or back fluid lumens.

It is also important to note that although the embodiment of application tray 1100 presented in this work in has four ports (first port 1142a, second port 1142b, third port 1142c, and forth port 1142d), other embodiments of application tray 1100 may have three ports, or between five and ten ports or greater.

The liquid-contacting chamber (LCC) 1154a, mentioned above, is located in top piece 1102, defined by front liquid lumens (1102a, 1102b, 1102c, and 1102d), back liquid lumens (1102e, 1102f, and 1102g), base membrane 1156, and back gum-sealing membrane 1158.

Though not shown, bottom piece 1104 also has a LCC 1154b, defined by front liquid lumens (1104a, 1104b, 1104c, and 1104d), back liquid lumens (1104e, 1104f, and 1104g), base membrane 1156, and back gum-sealing membrane 1158.

The multi-lumen design provides bidirectional or dedicated lumens for flow and vacuum that are self-reinforcing and therefore do not collapse under vacuum or rupture under pressure while in use, maximizing the structural integrity, while minimizing the size of the overall application tray 1100 for user comfort during insertion, in-use, and upon removal. This decreased size also serves to provide an enhanced effective seal of the application tray in the oral cavity.

If the multiple lumens (1102a, 1102b, 1102c, 1102d, 1102e, 1102f, 1102g, 1104a, 1104b, 1104c, 1104d, 1104e, 1104f, and 1104g) are connected as described above, they form a lumen hinge sections (1103 on FIG. 5). This may result in the multi-lumen design providing conformance in the X, Y and Z directions, due to the flexibility of lumen hinge sections 1103 between each lumen. This design allows effective and feasible conformance to a variety of different users teeth and gum topography, providing the effective gum sealing without irritating the gums and allowing dynamic positioning of the fluid cleaning jets around each of the teeth to obtain proximal and interdental cleaning action. The multiple lumens are also attached to the first manifold 1146 and second manifold 1148. This creates a secondary flexible joint providing two additional degrees of motion for the adjusting to different bite architectures that may be encountered.

The back gum-sealing membrane 1158 proves a flexible and universal sealing mechanism to minimize leakage into the oral cavity while redirecting flow onto and around teeth, to maximize treatment/cleaning area to get to hard-to-reach-places (HTRP). The membrane can provide an elastic function across the lumen longitudinal axis to form around the teeth and gums.

Base membrane 1156 provides the flexibility required for effective fit or sealing within the oral cavity and allowing redirection and flow of jets back towards the teeth and/or gingival surfaces.

Optionally, application tray 1100 could also include gum-sealing component if required, which could be attached to the front fluid lumens 1102a, 1102b, 1104a, and 1104b, and back fluid lumens 1102e and 1104e (member furthest from teeth).

Optionally, frictional elements, such as filament tufts, could also be placed or secured through any of the lumen hinge sections 1103 without significantly increasing the size of application tray 1100, or impacting user comfort or fluid flow in the application tray 1100.

Inner front wall jet slots 1132 are located on inner front wall of top piece 1102 and bottom piece 1104, while inner back wall jet slots 1134 are located on inner back wall of top piece 1102 and bottom piece 1104. The number, shape and size of inner front wall jet slots 1132 and inner back wall jet slots 1134 affect the cleaning of the teeth and gums, and can be designed to direct jets of cleaning fluid in a variety of spray patterns. The inner front wall jet slots 1132 and inner back wall jet slots 1134 shown in FIGS. 4 to 8 are only one embodiment of jet slot configuration.

FIGS. 4 through 8 depict an embodiment of an application tray 1100 in which surfaces of the users top and bottom teeth and/or gingival area are substantially simultaneously contacted by fluid to provide the desired beneficial effect. It should be understood that, in other embodiments, application tray 1100 may be designed to contact only the top or bottom teeth and/or gingival area of the user.

FIG. 7 is a partial cross-sectional view of the device of FIG. 4. The figure shows first port 1142a, second port 1142b, third port 1142c, forth port 1142d, feeding first manifold 1146 and second manifold 1148. Specifically, second port 1142b and third port 1142c, feed first manifold sections 1146a and 1146b, respectively, while first port 1142a, and forth port 1142d feed second manifold sections 1148a and 1148b, respectively.

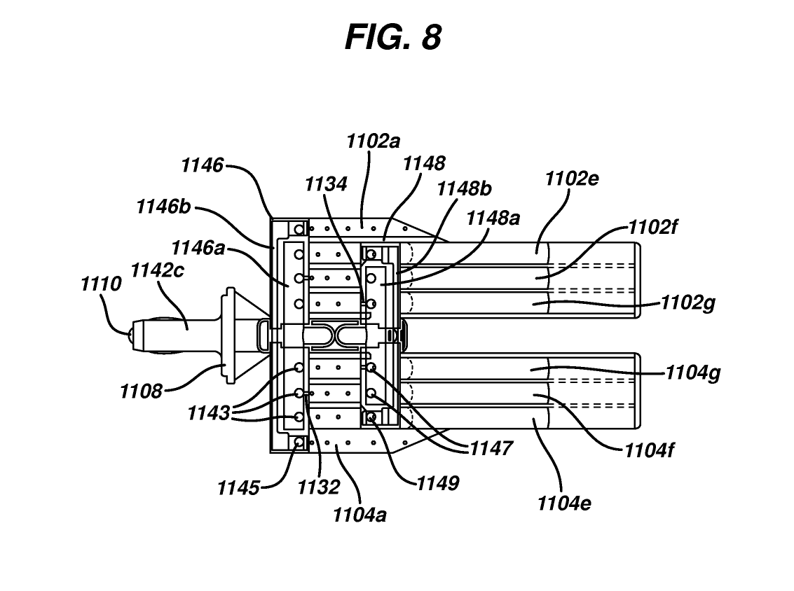

FIG. 8 is a cross-sectional view of the application tray 1100 of FIG. 6 along the 8-8 plane. The figure shows first manifold 1146 with first manifold sections 1146a and 1146b, and second manifold 1148, with second manifold sections 1148a and 1148b. In one embodiment of a cleaning operation, cleaning fluid is pumped through second port 1142b and third port 1142c, and enters first feed manifold sections 1146a and 1146b. Fluid enters front fluid lumens 1102a, 1102b, 1102c, 1102d, 1104a, 1104b, 1104c and 1104d through front fluid lumen ports 1143 and 1145. The cleaning fluid then enters LCCs 1154a and 1154b through inner front wall jet slots 1132. A vacuum is pulled on first port 1142a and forth port 1142d pulling vacuums on second manifold sections 1148a and 1148b. This vacuum pulls the cleaning fluid through inner back wall jet slots 1134 into back fluid lumens 1102e, 1102f, 1102g, 1104e, 1104f, and 1104g. The fluid enters second manifold sections 1148a and 1148b through back fluid lumen ports 1147 and 1149, then flows into first port 1142a and forth port 1142d.

In this embodiment, jets of cleaning fluid are first directed from first manifold 1146 to the front surfaces of the teeth and/or gingival area from one side of the LCCs, directed through, between, and around the surfaces of the teeth and/or gingival area from the other side of the LCCs into the second manifold 1148 to provide controlled interdental, gumline, surface and/or gingival area cleaning or treatment.

In some embodiments, the flow in the manifolds is then reversed. Cleaning fluid is pumped through first port 1142a and forth port 1142d, and enters second manifold sections 1148a and 1148b. Fluid enters back fluid lumens 1102e, 1102f, 1102g, 1104e, 1104f, and 1104g through back fluid lumen ports 1147 and 1149. The cleaning fluid then enters LCCs 1154a and 1154b through inner back wall jet slots 1134. A vacuum is pulled on second port 1142b and third port 1142c, which pulls the cleaning fluid through inner front wall jet slots 1132, into front fluid lumens 1102a, 1102b, 1102c, 1102d, 1104a, 1104b, 1104c and 1104d. The fluid enters first feed manifold sections 1146a and 1146b through front fluid lumen ports 1143 and 1145, and finally into second port 1142b and third port 1142c.

In the second portion of this embodiment, jets of cleaning fluid are directed onto the back surfaces of the teeth and/or gingival area, and directed through, between, and around surfaces of the teeth and/or gingival area. The alternating of pressure/vacuum through a number of cycles creates a turbulent, repeatable and reversible flow to provide reciprocation of fluid about the plurality of surfaces of the oral cavity to substantially simultaneously contact the surfaces of the oral cavity with fluid, thereby providing the desired beneficial effect.

In another embodiment it may be preferable to deliver the fluid through one or both manifolds simultaneously, flooding LCCs 1154a and 1154b, submerging the teeth for a period of time and then evacuating the LCCs after a set period of time through first port 1142a, second port 1142b, third port 1142c, forth port 1142d, feeding first manifold 1146 and second manifold 1148. Fluid then simultaneously enters front fluid lumens 1102a, 1102b, 1102c, 1102d, 1104a, 1104b, 1104c and 1104d through front fluid lumen ports 1143 and 1145, and back fluid lumens 1102e, 1102f, 1102g, 1104e, 1104f, and 1104g through back fluid lumen ports 1147 and 1149. The cleaning fluid then enters LCCs 1154a and 1154b through inner front wall jet slots 1132 and inner back wall jet slots 1134. To evacuate the LCCs, a vacuum is simultaneously pulled on first manifold 1146 through second port 1142b and third port 1142c, and second manifold 1148 through first port 1142a and forth port 1142d. Cleaning or treatment fluid is pulled through inner front wall jet slots 1132 and inner back wall jet slots 1134, into first manifold 146 and second manifold 148.

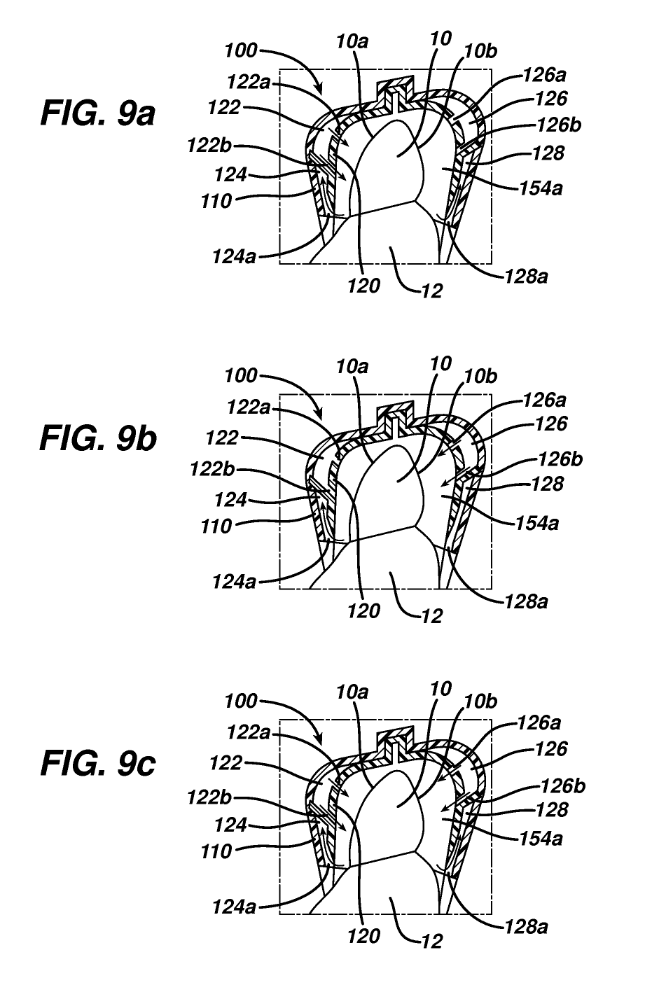

FIG. 9a through 9c are partial cut-away views of the application tray 100 in several other operating modes. The figures all show tooth 10 and portion of gums 12 contained in liquid-contacting chamber (LCC) 154a formed by inner wall 120 of application tray 100. Tooth 10 has first side 10a and second side 10b. In the cut-away views, application tray 100 has outer wall 110 and inner wall 120. Manifolds defined by outer wall 110 and inner wall 120 include first manifold 122, second manifold 124, third manifold 126, and fourth manifold 128. The figures also show some of the nozzles for each of the manifolds. Nozzles 122a and 122b are in shown in first manifold 122. Nozzle 124a is shown in second manifold 124. Nozzles 126a and 126b are shown in third manifold 126. Nozzles 128a is shown in fourth manifold 128.

In the operating mode shown in FIG. 9a, pressure is put on the fluid in first manifold 122, while vacuum is pulled on second manifold 124 and fourth manifold 128. Fluid from first manifold 122 enters fluid-contacting chamber (LCC) 154a through jet slots 122a and 122b which are directed toward first side 10a of tooth 10. Fluid leaves LCC 154a through jet slots 124a in second manifold 124 and jet slot 128a in fourth manifold 128.

In the operating mode shown in FIG. 9b, pressure is put on the fluid in third manifold 126, while vacuum is pulled on second manifold 124. Fluid from third manifold 126 enters fluid-contacting chamber (LCC) 154a through jet slots 126a and 126b which are directed toward second side 10b of tooth 10. Fluid leaves LCC 154a through jet slots 124a in second manifold 124.

In the operating mode shown in FIG. 9c, pressure is put on the fluid in first manifold 122 and third manifold 126, while vacuum is pulled on second manifold 124 and fourth manifold 128. Fluid from first manifold 122 and third manifold 126 enters fluid-contacting chamber (LCC) 154a through jet slots 122a and 122b, and jet slots 126a and 126b, respectively. In this mode, fluid is simultaneously directed toward first side 10a and second side 10b of tooth 10. Fluid leaves LCC 154a through jet slots 124a in second manifold 124 and jet slot 128a in fourth manifold 128.

Though five modes of operation of application tray 100 have been presented, it is to be understood that there are many other operating modes in which pressure/vacuum may be placed on the fluid contained in first manifold 122, second manifold 124, third manifold 126, and fourth manifold 128. In each of these modes, the fluid dynamics for cleaning or treating first side 10a and second side 10b of tooth 10 may differ, and optimum methods of cleaning or treating the teeth of the user may be determined.

It is also possible to deliver different fluid compositions to first manifold 122, second manifold 124, third manifold 126, and fourth manifold 128. The different fluid compositions would then combine in the LCC for improved cleaning efficacy or treatment effects. In the dual manifold design it may be preferable to supply each manifold from a separate fluid supply reservoir, such as in a dual action piston pump configuration, where one supply line connects to supply first manifold 1146 and the other piston supply line provides and removes fluid from second manifold 1148, e.g. when one manifold is being supplied with fluid the second manifold is removing fluid, and vice versa.

Returning to the embodiment of an application tray 1100 presented in FIGS. 4 through 8, valves may be inserted to further control the flow of fluid through the manifolds. In some embodiments, valves can be placed at front fluid lumen ports (1143, 1145) of front fluid lumens 1102a, 1102b, 1102c, 1102d, 1104a, 1104b, 1104c and 1104d, or at back fluid lumen ports (1147, 1149) of back fluid lumens 1102e, 1102f, 1102g, 1104e, 1104f, and 1104g to provide improved function by allowing lumens to engage at different times (at different points in the cleaning/treatment cycle), at pulsed intervals. As an example, in one embodiment, not all lumens engage in the fluid pumping/vacuum function. Here, front fluid lumens 1102a and 1104a, and back fluid lumens 1102e and 1104e, which primarily engage the gums, only engage in the fluid vacuum function. This would help prevent fluid from leaking into the oral cavity. Valving also allows for variable flow, allowing a decreased resistance to the fluid vacuum function, or allowing increased pumping, and therefore fluid velocity, during fluid delivery.

In still other embodiments, individual inner front wall jet slots 1132 or inner back wall jet slots 1134 may have integrated one-way valves, such as duckbill valves or umbrella valves, to allow flow only in one direction out of those particular jets. This may be effective to increase vacuum relative to pressure/delivery in the LCC.

In some embodiment, the motion of the frictional elements discussed above, relative to the teeth, could be applied by a single or combination of mechanisms including, by not limited to, the fluid (via the jet slots or via turbulence of flow); movement of the membrane via the pulsing of the flexible application tray 1100; an external vibrational mechanism to vibrate the frictional elements; linear and or rotational movement of the application tray 1100 around the teeth through user jaw motion or external driving means.

In other embodiments, a conformable substance, such as gel, may be disposed near the back gum-sealing membrane 1158, allowing application tray 1100 to comfortably fit against the back of the mouth. Alternatively, the end of application tray 1100 may have a mechanism or attachment to extend or decrease the length of the mouthpiece to the proper length for each individual user, providing a semi-custom fit.

Manufacturing of the multi-lumen design is feasible utilizing existing available manufacturing and assembly processes such as extrusion, injection, vacuum, blow, or compression molding. Other feasible techniques include rapid prototyping techniques such as 3D printing and other additive techniques, as well as subtractive techniques.

The application tray may be custom manufactured for each individual user, or customizable by the individual user prior to use. For custom manufacture of the application tray, vacuum form molds can be created directly or indirectly from user teeth and gingival impressions, which create a model of the teeth which can then be modified to create required clearances and flow channels. These vacuum form molds can be created at low cost utilizing CAD and rapid prototyping processes.

One manufacturing method is to create individual component shells through vacuum forming. Low cost methods allow vacuuming forming of very thin wall structures. The component geometry is designed to provide the interlocking features and structural geometry to allow minimization of the size of the application tray. When assembled, the manufactured components form the necessary manifolds and flow structure (bidirectional and/or dedicated manifolds) to provide the required performance characteristics for treating/cleaning the teeth.

Customized mouthpieces are based on the user's teeth geometry, therefore creating a consistent distance between the mouthpiece and teeth may provide a more consistent cleaning/treating experience. The materials for each of the two-piece shell may be different, therefore allowing for softer material (on the inside shell) where it contacts teeth/gums and harder material on the outside shell to maintain rigidity and the overall shape.

For customizable application trays, tray pre-forms (similar to sport mouth guards or teeth grinding appliances) containing pre-manufactured manifolds, nozzles and channels are mass manufactured. The tray pre-forms can be created through a variety of known manufacturing techniques including, but not limited to, blow molding, vacuum forming, injection and/or compression molding. The material used in the pre-form would be a low temperature deformable plastic material. The pre-form would be used in conjunction with required spacers to be applied over the teeth to provide required clearance, cleaning and/or treatment performance. Once the clearance components are applied to the teeth, the pre-form would be heated via microwave or by placing in boiling water so as to be pliable. The pliable pre-form would be applied onto the user's teeth and gingival area to create the customized application tray.

The application tray can be integrated with stressing features to allow elastic conformance to maximize positioning, comfort and performance during application and in use. For example, spring-like elements such as shins, clips and elastic bands may provide fitting over and against gums.

Materials for the mouthpiece lumen could range from lower durometer flexible materials (25 shore A) to harder materials more rigid materials (90 shore A), preferably being between 30 and 70 shore A.

Materials could be silicone, thermoplastic elastomer (TPE), polypropylene (PP), polyethylene (PE), polyethylene terephthalate (PET), ethylene vinyl acetate (EVA), polyurethane (PU), or multi-component (combination of materials and hardness) to achieve desired design and performance attributes.

The jet openings or slots could be made through a secondary operation such as drilling or punching, or formed during molding. Alternatively, the jet openings or slots could be inserted into the application tray to provide increased wear and or different jet performance characteristics, and could be combined with frictional cleaning elements or other components to enhance the cleaning and/or treatment affect.

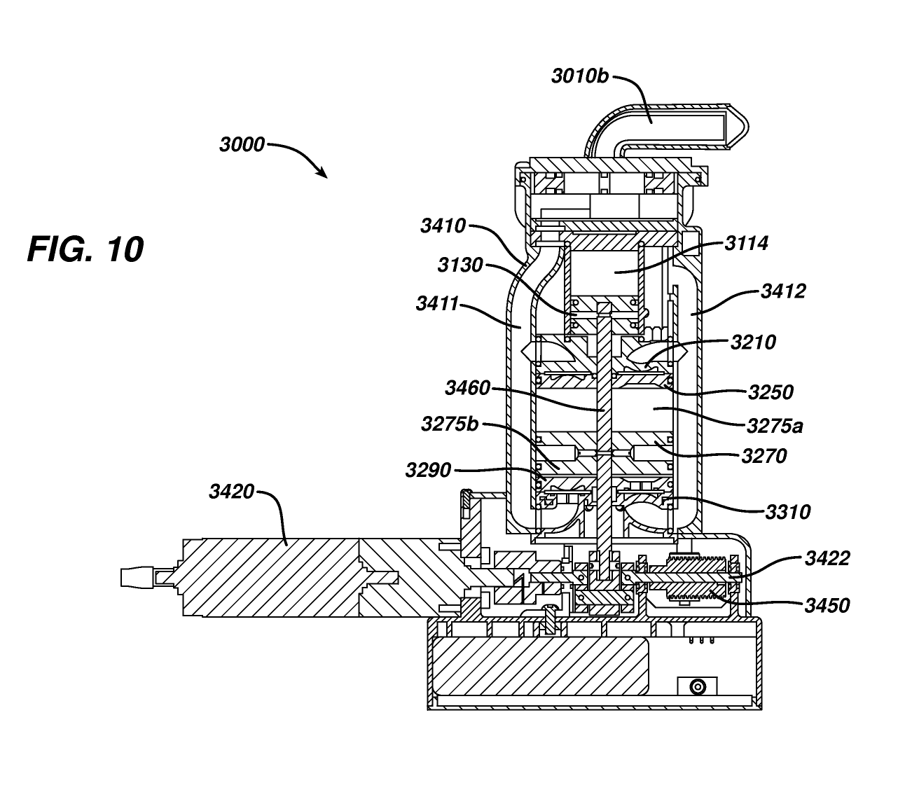

An embodiment of a hand-held device used with devices according to the present invention is shown in FIG. 10. The device has previously been presented in U.S. Patent Publication US2011002776, and will be briefly described below.

FIG. 10 is a cut-away view of device 3000, showing the spatial relationships between the components in the pumping section, vacuum section, and pumping and driving sections. Cylinder volume 3412 is the volume of vacuum cylinder sleeve 3410 not occupied by the components of the pumping section, vacuum section, and pumping and driving sections, and serves as the fluid reservoir in the embodiment shown. The general operation of device 3000, is as follows:
1. Device 3000 is sufficiently filled with cleaning fluid. The fluid initially resides in cylinder volume 3412 of vacuum cylinder sleeve 3410.
2. The user inserts any embodiment of an application tray, for example application tray 100, into their mouth. Device 3000 may be activated by a sensor (pressure sensor, proximity sensor, etc.) or the device may be activated by the user. The cleaning cycle is initiated.
3. On the “down stroke” of piston rod 3460, delivery piston 3130 pulls fluid from the bottom of cylinder volume 3412 through several one-way valves, and finally into delivery volume 3114.
4. On the “upstroke” of piston rod 3460, delivery piston 3130 forces the fluid though several one-way valves, and finally through base port 742 of reciprocating flow controller 710 (see FIGS. 3).
5. Fluid flow through reciprocating flow controller 710 is described earlier using FIG. 3c and FIG. 3d. In brief, when reciprocating flow controller 710 in its first position (FIG. 3c), incoming fluid from delivery volume 3114 enters reciprocating flow controller 710 through base port 742. The fluid exits reciprocating flow controller 710 through cap port 722, flowing into outlet pipe 3010b. Returning fluid, flowing in through outlet pipe 3010a, reenters reciprocating flow controller 710 through cap port 724. The fluid exits reciprocating flow controller 710 through base port 744. When reciprocating flow controller 710 in its second position (FIG. 3d), incoming fluid from delivery volume 3114 enters reciprocating flow controller 710 through base port 742. The fluid exits reciprocating flow controller 710 through cap port 724, flowing into outlet pipe 3010a. Returning fluid, flowing in through outlet pipe 3010b, reenters reciprocating flow controller 710 through cap port 722. The fluid re-exits reciprocating flow controller 710 through base port 744. Reciprocation of cleaning fluid in application tray 100 of FIG. 1 is achieved by switching reciprocating flow controller 710 between its first and second positions.
6. In the present embodiment, the vacuum section of device 3000 is effective during both the “upstroke” and “down stroke” of piston rod 3460. Vacuum piston 3270 is dual acting, and draws fluid from application tray 100 on both the upstroke and down stroke of vacuum piston 3270. The fluid flowing through base port 744 of reciprocating flow controller 710 flows through several sections of device 3000, arriving in cylinder volume 3412. The fluid in cylinder volume 3412 is then drawn to vacuum volumes 3275a or 3275b. During the “upstroke” of piston rod 3460, the fluid in cylinder volume 3412 is drawn through several ports and one-way valves, arriving in vacuum volume 3275b. During the “down stroke” of piston rod 3260, the fluid in cylinder volume 3412 is drawn through several ports and one-way valves, arriving in vacuum volume 3275a. As noted, the vacuum piston 3270 in this embodiment is dual acting, drawing fluid from application tray 100 on both the upstroke and down stroke of vacuum piston 3270. So, while vacuum volume 3275b is drawing in fluid from cylinder volume 3412, the fluid in vacuum volume 3275a is being pumped into cylinder volume 3412. In contrast, while vacuum volume 3275a is drawing in fluid from cylinder volume 3412, the fluid in vacuum volume 3275b is being pumped into cylinder volume 3412. During the “upstroke” of piston rod 3460, the fluid in vacuum volume 3275a is pumped through several ports and one-way valves, arriving in cylinder volume 3412. During the “down stroke” of piston rod 3260, the fluid in vacuum volume 3275b is pumped through several ports and one-way valves, arriving in cylinder volume 3412.
7. The cycle continues with cycles comprising both “upstrokes” and “down strokes” of piston rod 3260, with fluid motion through device 3000 as described in steps 3 through 6 above.

The ratio of the total volume of vacuum volumes 3275a and 3275b to delivery volume 3114 may be any range, such as 1:1, optionally about 3:1 or greater, or about 4:1 or greater. Since delivery piston 3130 only delivers fluid on one “half” of the pumping/vacuuming cycle, while vacuum piston 3270 works on both halves of the cycle, the ratio of the volume of fluid delivered to application tray 100 to the volume of fluid drawn from application tray 100 is 8:1 per cycle. The dual acting vacuum piston 3270 also provides vacuum during the half of the stroke where delivery piston 3130 is not delivering fluid, increasing the opportunity to retrieve fluid from application tray 100, as well as clear additional fluid which leaked from application tray 100 into the oral cavity. Testing has shown a minimum 3:1 volumetric ratio of fluid vacuum to fluid delivery per stroke provided the necessary vacuum to minimize leakage into the oral cavity from application tray 100 when the tray has a marginal gingival seal, which may occur in embodiments of a universal (designed to fit a range of people) application tray 100 design.

In some embodiments vacuum piston 3270 is single acting. However, a dual acting vacuum piston 3270 may show some advantages.

In one embodiment, the hand-held device will be a self-contained, portable unit with a rechargeable battery, have a motor-driven piston pump for fluid delivery, have a mechanism to control the fluid flow, keep the temperature within a specified range, be modular in design, and have ergonomics well-suited to the user's hand. When the hand piece is in the base station, it will recharge the battery, refill the fluid reservoirs in the hand piece from those in the base station, and exchange samples and/or diagnostic information with the base station. It may also go through a cleaning process.

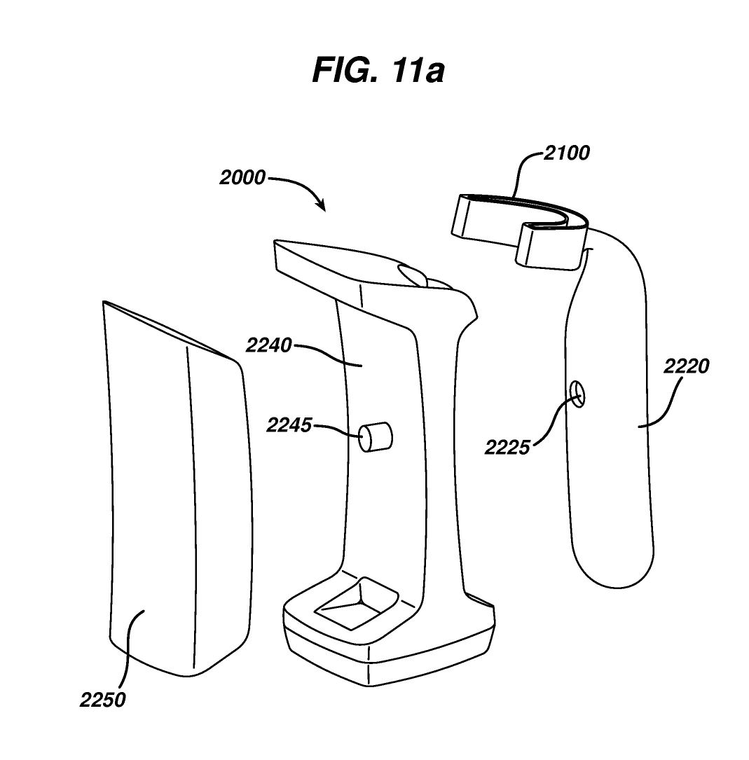

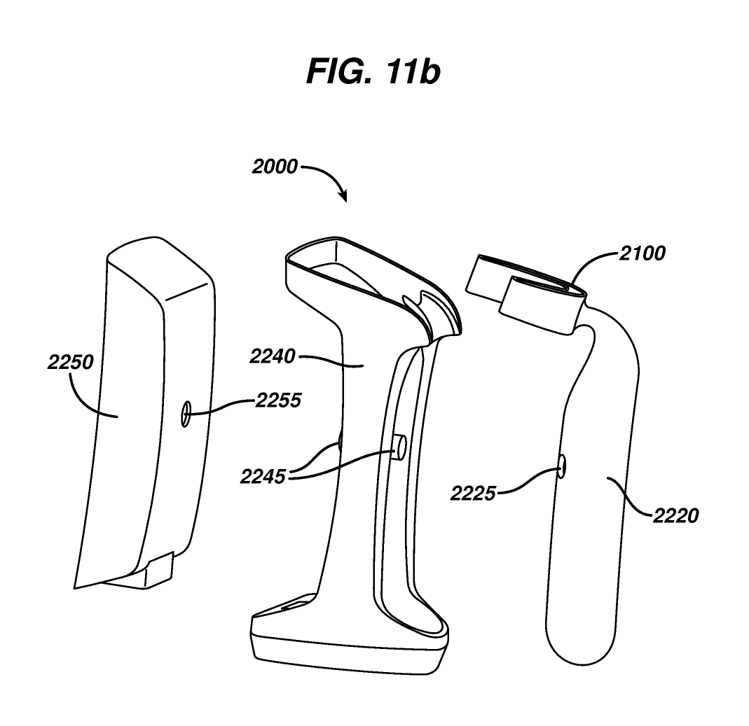

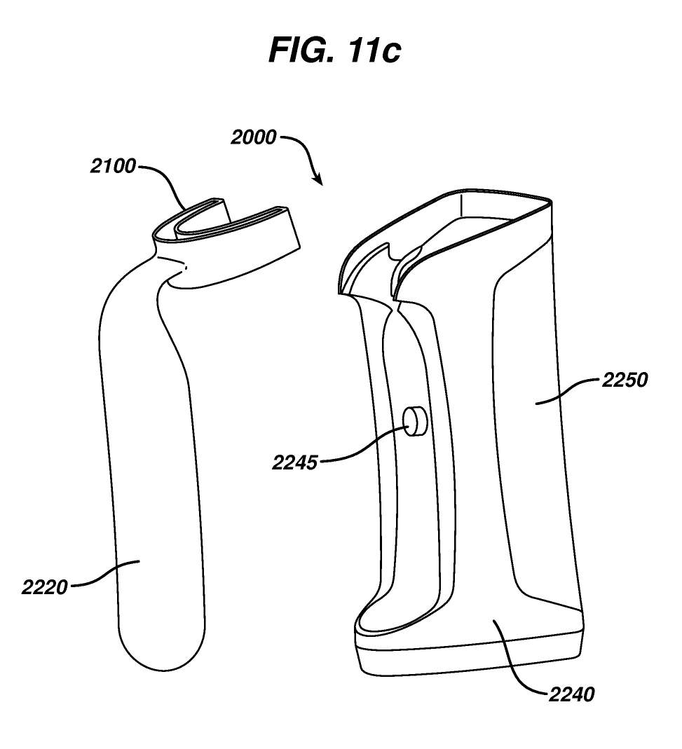

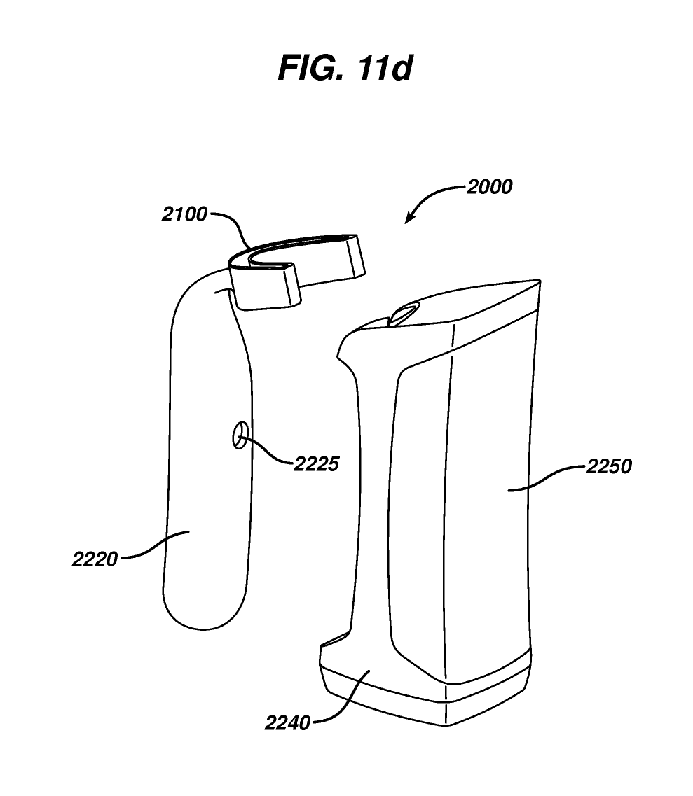

FIGS. 11a-11d show a representation example of an embodiment of a dental cleaning system 2000. The figures show dental cleaning system 2000, showing hand-held device 2220, base station 2240, and base station fluid reservoir 2250. Base station fluid reservoir 2250 is used to refill the fluid reservoirs in device 2220. Application tray 2100 is shown attached to device 2220.

In this embodiment, base station fluid port 2245 is the conduit through which cleaning or treatment fluid passes from base station fluid reservoir 2250 to the fluid reservoirs in device 2220. Fluid leaves base station fluid reservoir 2250 through base station fluid reservoir port 2255, and enters the fluid reservoirs in device 2220 through port 2225.

When in base station 2240, the internal battery of device 2220 will recharge, and the fluid reservoirs in device 2220 will refill from those in base station 2240. Any diagnostic information in device 2220 will be exchanged with base station 2240. Device 2220 may also go through a cleaning process.

In other embodiments, a piston pump with check-valves will be used for fluid delivery and/or removal.

In yet other embodiments, a rotary piston pump will be used for fluid delivery and/or removal. This pump is known by those in the art, and the piston rotates as it reciprocates, therefore not needing any valves to operate. Reversing the rotation direction of the drive motor will reverse the fluid flow direction.

In still other embodiments diaphragm pumps, gear pumps, or double-action piston pumps will be used for fluid delivery and/or removal. In the case of double-action piston pumps, when the fluid system is charged, this pump type has the benefit of reciprocating the direction of the fluid flow to the mouthpiece. Charged pneumatic cylinders, hand pump, or rotary pumps may be used to drive the system.

Though several embodiments have been described, it should be understood that the scope of the present invention embraces other possible variations, being limited only by the contents of the accompanying claims, which includes the possible equivalents.

What is claimed is:

1. A device for directing a fluid onto a plurality of surfaces of an oral cavity of a mammal, said device comprising,
a chamber for maintaining said fluid proximate said plurality of surfaces, said chamber defined by front and rear inner walls and a base inner wall of said device, said base inner wall extending between said front and rear inner walls, said front and rear inner walls comprising a plurality of openings,
a first manifold for containing a first portion of said fluid and providing said first portion to said chamber through said openings of said front inner wall,
a second manifold for containing a second portion of said fluid and providing said second portion to said chamber through said openings of said front inner wall,
a third manifold for containing a third portion of said fluid and providing said third portion to said chamber through said openings of said rear inner wall,
a fourth manifold for containing a fourth portion of said fluid and providing said fourth portion to said chamber through said openings of said rear inner wall,
a first port for conveying said first portion of fluid to and from said first manifold,
a second port for conveying said second portion of fluid to and from said second manifold,
a third port for conveying said third portion of fluid to and from said third manifold,
a fourth port for conveying said fourth portion of fluid to and from said fourth manifold; and
means for providing an effective seal of said device within said oral cavity.

2. The device of claim 1 further comprising means for attaching said device to means for providing said fluid to said device.

3. The device of claim 2 wherein said attachment means comprises a quick disconnect structure for attaching said device to said means for providing said fluid to said device.

4. The device of claim 2 wherein said attachment means comprises a support plate fixedly attached to the front of said device and having first, second, third and fourth ports extending there through, said support plate comprising a structure for attaching said device to said means for providing fluid to said device.

5. The device of claim 1 comprising a plurality of front lumens connected by said first manifold and a plurality of rear lumens connected by said second manifold.

6. The device of claim 1 wherein the number, location and cross-sectional geometry of said openings are effective to provide a spray pattern effective to provide a beneficial effect to the oral cavity.

7. The device of claim 1 comprising a top piece and a bottom piece for providing substantially simultaneous contact of a plurality of surfaces of both top and bottom sections of said oral cavity.

8. The device of claim 1 wherein the cross-sectional geometry of said openings is selected from the group consisting of circular, elliptical and trapezoidal.

9. The device of claim 1 wherein said base inner and outer walls comprise a flexible membrane for providing said effective seal.

10. The device of claim 9 comprising a flexible gum-sealing membrane for providing said effective seal.
